(19) United States
(12) Patent Application Publication
(10) Pub. No.: US 2003/0009320 A1
(43) Pub. Date: Jan. 9, 2003

(54) Automatic language translation system

(75) Inventor: Toshio Furuta, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/188,979

(22) Filed: Jul. 5, 2002

(30) Foreign Application Priority Data
Jul. 6, 2001 (JP) 205640/2001

(51) Int. Cl. G06F 17/28

(52) U.S. Cl. 704/2

(57) ABSTRACT

An automatic language translation system is available for translating original language text obtained from a server via the Internet. This system can be configured more easily than conventional systems. An automatic language translation system translates original language text information that a user has obtained from a server through a user terminal. The translation is graded by the user When the user gives the translation a low grade, the translation mechanism has a translator revise it, and the revisions are registered in a translation dictionary. Thus, the registered revisions can be reflected in the next translations.

### FIELD OF THE INVENTION

The present invention relates to the automatic language translation field, more particularly to a system for automatically translating an original language text obtained from a special server via the Internet. This system can be configured more easily than conventional systems.

### BACKGROUND OF THE INVENTION

Communication networks such as the Internet have become widely used, and information is provided over the networks in a variety of languages from servers. An automatic language translation device is used in some cases for translating text information in original languages other than the user's native language. Conventional automatic language translation devices can be practical for translating content that includes many photographs and a little text. Using a conventional device on content like catalogues does not produce a sufficiently comprehensible translation.

On the other hand, when the conventional device translates content such as reports, editorials, critiques, and opinions, which have a large amount of original language text information, users may not understand the translation or may feel something is wrong with it. In other words, the translating ability of the conventional system is not up to user's expectations, which are a main cause for the difficulty in popularizing such systems.

Nowadays the number of English speakers around the world is estimated at 800 million people and growing. Most of the people who are engaged in international transactions or intellectual occupations are required to have knowledge of English. In addition, widespread use of the Internet boosts the need for English. If it becomes possible to translate English automatically into reasonably natural Japanese and vice versa, people who use Japanese and English, as part of their job will reap immeasurable benefits. Accordingly, various research organizations have continually striven to achieve an automatic language translation device that is capable of translating at the natural level.

However, those research organizations have generally tried to settle all the matters that arise in achieving automatic translation at the language level in the software and hardware of the device, thus causing a lag in its practical use and commercialization.

Meanwhile, automatic language translation devices are set up on the Internet for free or for a reasonable fee, and experts in a wide range of fields as well as professional translators use them.

### SUMMARY OF THE INVENTION

An objective of the present invention therefore is to provide a system for automatically translating original language texts obtained from a server via the Internet, which can be configured more easily than conventional systems.

To achieve the above objective for the present invention, an automatic language translation device automatically translates original language text information obtained through a communication network, the translation is revised, and the revision is reflected in the device.

That is, the device automatically translates original language text information first and, a professional translator in the field of the information, for example revises it. After that, the revision being reasonably natural in expression is added to the device. Herewith, raising the quality of translations through the automatic language translation device will possibly be easier compared with conventional techniques, which only attempt to improve the software and hardware in the device.

### BRIEF DESCRIPTION OF THE DRAWINGS

The objects and features of the present invention will become more apparent after considering the following detailed description that was taken in conjunction with the accompanying drawings:

FIG. 1 is a block diagram showing the construction of the system based oil the functioning of the present invention;

FIG. 2 is a block diagram showing the construction of a server in the system of FIG. 1;

FIG. 3A is an example of original language text information;

FIG. 3B is an example of translation (primary translation) using a conventional device;

FIG. 4 is an example of a revised translation (secondary translation) by an expert; and

FIG. 5 is a flowchart for explaining the operation of the system

### DESCRIPTION OF THE PREFERRED FUNCTIONING

Referring now to the drawings, a description of the preferred functioning of the present invention will be given in detail.

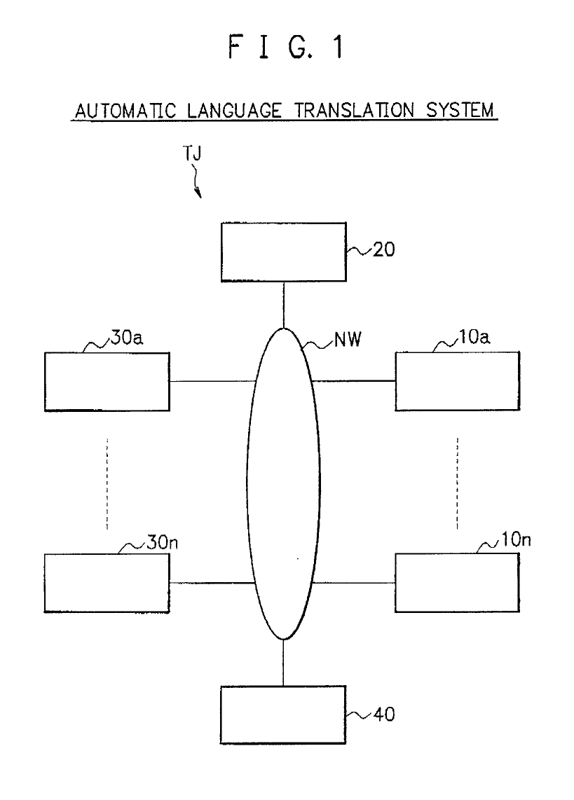

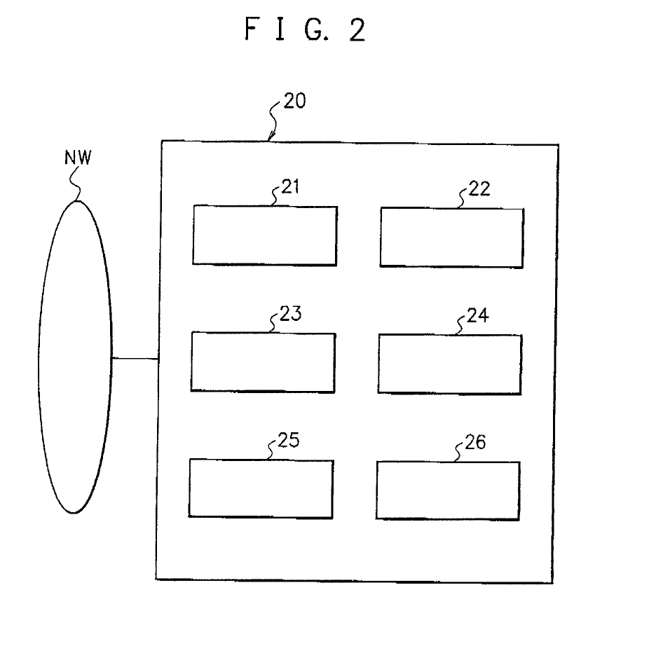

FIG. 1 is a block diagram showing the construction of system TJ according to the functioning of the present invention. FIG. 2 is a block diagram showing the construction of server 20 in system TJ.

As shown in FIG. 1, system TJ consists of a plurality of user terminals (10a-10n), server 20 as an original automatic language translating mechanism capable of handling multiple languages, a plurality of translator (expert) terminals (30a-30n), server 40 for sending language information (original language text), communications network (Internet, etc.) NW for interconnecting them.

Referring to FIG. 2, server 20 includes automatic translating mechanism 21 for automatically translating an original language (e.g., Japanese) into a language specified by a user (e.g., English), and translation dictionary mechanism 22 for storing words, phrases (idioms), and sentences in the translation language corresponding to sentences in the original one. Server 20 also includes translation access information recording mechanism 23, statistics aggregating mechanism 24, natural language pattern learning mechanism 25, and automatic transmitting mechanism 26, which will be described below.

Incidentally, automatic translating mechanism 21 can use a general automatic translation method such as the transfer (syntax directed translation) method, the PIVOT (intermediate language) method, or the trans-memory (case database) method.

Mechanism 23 carries out a registration function for registering or recording information such as access frequency, indicating the number of accesses to the same original language text information made by user terminals 10a to 10n (e.g., the number of accesses to respective articles A, B, to N), positional information of texts to be translated in server 40 (page identifier or URL, access day and time, and translation grade given by users, which indicates ratings for the translated text. The text may be rated on a scale of, for example, one to three.

Mechanism 24 carries out a secondary function for generating translation access statistics by processing every 24 hours the information registered by mechanism 23. The secondary function sets the texts given lower grades in an array in a descending order of access frequency count for the corresponding original language text, and adds information regarding the position of the corresponding original language text to that of the statistical processing.

Mechanism 25 carries out a function for adding a revised translation, which a professional translator has handled to render it reasonably natural by taking advantage of his/her expertise, to mechanism 22. Further details of mechanism 25 will be given later.

Mechanism 26 carries out a function for transmitting the translation access statistics (secondary information) accumulated by mechanism 23 to 30a to 30n, which are operated by registered translators whose abilities have been judged to be above a prescribed level based on a qualifying test or the like.

Each of the registered translators having terminals 30a to 30n selects a translated text, which has been given a lower grade, in his/her specialized field in descending order of access frequency count. The count is based on the information every 24 hours, sent from server 20. The translator revises the selected text so as to make it reasonably natural. Preferably, the translator revises it using the original language text as a reference by downloading it from server 40 using the positional information. Having revised the text, the translator sends the revision back to server 20. Subsequently, mechanism 25 pick up language patterns according to the revision, and stores or reflects them in mechanism 22. Thus, reflecting the language patterns in the next translation and providing a translated text at the natural language level are made possible.

The translators, who are professionals or experts in a particular area of work, or study, use terminals 30a to 30n.

For example, in the telecommunications sector, translators may specialize in such areas as heavy/light electricity (communication) or software. Preferably, the terminals are provided to those knowledgeable in even more specialized areas such as, for example, in the case of light electricity, broadcasting instruments, magnetic recording storage, digital or, analog circuitry.

Server 40 supplies content that has a large amount of linguistic information in various languages as original language text information over network NW. Examples of content include reports, editorials, critiques, and opinions.

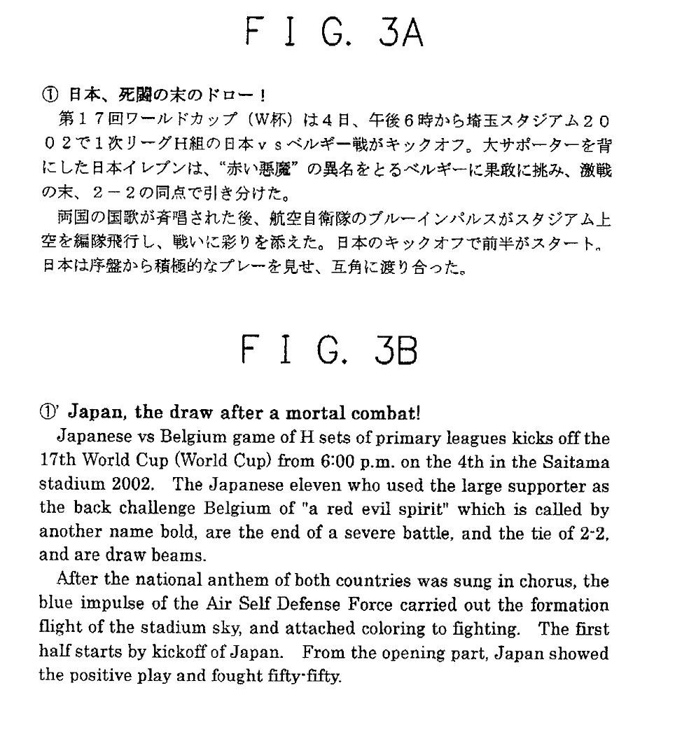

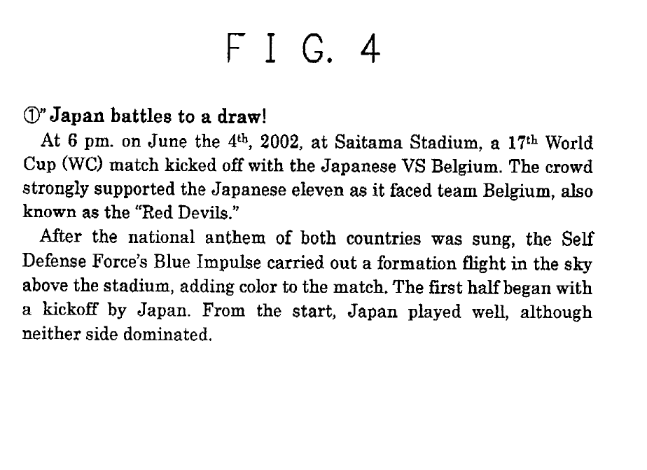

In the following, an example will be given for showing how to automatically translate an original language text with reference to FIGS. 3A, 3B and 4.

FIG. 3A is a Japanese text set as an original one, and FIG. 3B is an English translation (initial translation) using a conventional device. FIG. 4 is a revision (improved translation) of the initial translation in FIG. 3B by a professional translator. The text is obtained by the device based on the functioning of the present invention.

The Japanese text of FIG. 3A is an article on a World Cup football match between Belgium and Japan on the Jun. 4, 2002. The article states that the match ended in a 2-2 draw.

Referring to FIG. 3B, the device translates the title of the Japanese article denoted by \mathring{1} in FIG. 3A as “Japan, the draw after a mortal combat!” (\mathring{1}′) in the first translation. This translation could be considered grammatically correct in the absence of other information.

However, the translation uses poor, unnatural word choice. It is certainly different from a title an English newspaper article. Consequently, a translator compares sentence \mathring{1}′ with the sentence \mathring{1} and change it to the correct and natural “Japan battles to a draw!” denoted by \mathring{1}″ in the revised translation of FIG. 4. The translator then revises the entire first translation with reference to the original language text and creates an improved one, which uses appropriate and natural English.

Next in server 20, mechanism 25 picks up patterns from the improved in such a manner as to recognize “Japan battles to a draw!” (\mathring{1}″) as the natural English for Japanese sentence \mathring{1} under the condition of “the title of a newspaper article”, and registers the improved translation (pattern) in mechanism 22 as natural English text. Concrete methods for the pattern or syntax learning (recognition) and general idiom processing methods such as pattern matching (surface) and conversion tools (tree transducer) methods can be used. Thus, mechanism 25 learns patterns of syntax with respect to the whole Japanese article in FIG. 3A based on the corrected and revised text made by the translator, reflecting (registering) the patterns of syntax in mechanism 22.

Accordingly, during the next Japanese-English translation, the syntax of sentence \mathring{1}″ is adopted as the natural English translation if the condition of “the title of a newspaper article” is met. As described above, by registering a great deal of English syntax in association with the syntax of original languages in the translation dictionary mechanism automatically producing a natural English translation in combination with English syntax is possible.

Next, the operation of the system based on the functioning of the present invention will be described.

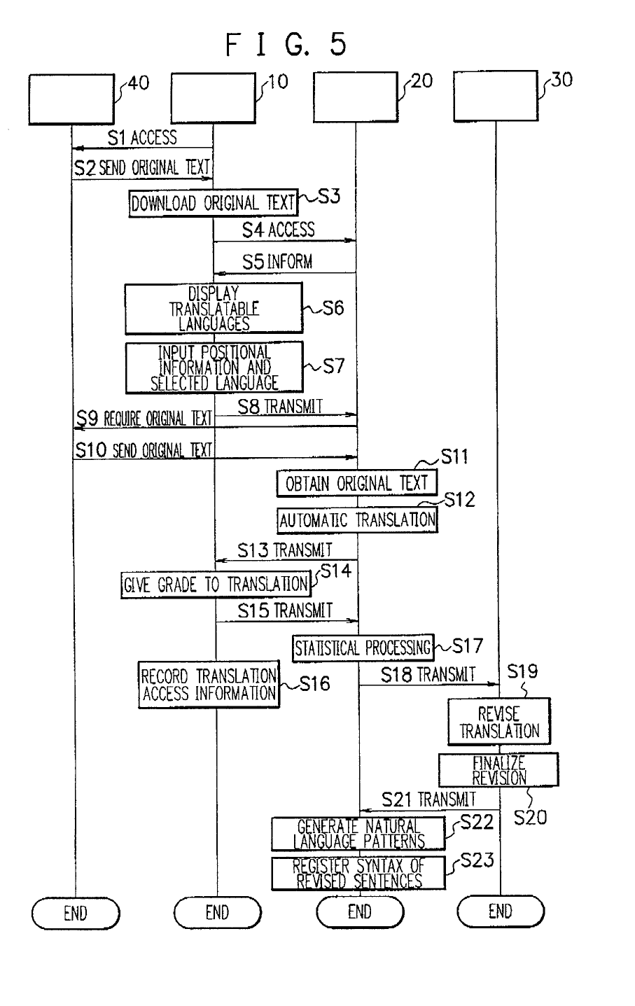

FIG. 5 is a flowchart for explaining the. As can be seen in the figure, first a user accesses server 40 through user terminal 10 and designates an original language text to be sent from server 40 (step S1). Server 40 sends the designated text to user terminal 10 in response (step S2).

User terminal 10 downloads the original language text to confirm it as the desired information (step S3). Subsequently, the user accesses server 20 through user terminal 10 (step S4). Server 20 informs user terminal 10 of languages (e.g., German, Russian, and Japanese) that it is able to translate (step S5). The languages are displayed (step S6). The user selects a language (e.g., Japanese) that the user intends to have translated and inputs the positional information (page identifier or URL) of the original language text information in server 40 (step S7). Then, the user transmits the information (the selected language and positional information) to server 20 (step S8).

Server 20 requires server 40 to transmit the original language text information with the use of the positional information (step S9). Server 40 sends the required original language text information to server 20 in response (step S10). Having obtained the original language text information (step S11), server 20 automatically translates the original language into the language selected by the user (step S12). The translated text is sent to user terminal 10 (step S13).

The user checks the translation (initial translation) displayed on the screen of user terminal 10 and rates it on a scale of, for example, one to three (step S14). User terminal 10 informs server 20 of the rating as translation grade information in addition to such information as the access date and the positional information (step S15). User terminal 10 also records the translation grade, access date, and positional information, etc., as translation access information (step S16).

In server 20, mechanism 23 writes (records) the translation access information received from user terminal 10. Statistics aggregating mechanism 24 processes the information (automatic translation grade, access frequency, access date, position information, etc.) associated with the translation (step S17), and automatically sends this information (referred to as translation access statistics) to translator terminal 30 every 24 hours (step S18).

The translator using terminal 30 checks the translation access statistics and uses them to select a translation in his/her specialized field to revise. An initial translation having more frequently accessed original language text information, and a lower grade may be selected at this time. After that, the translator asks server 40 via terminal 30 for the original language text using the positional information. The original language text is displayed on the screen of terminal 30, and the translator revises the initial translation with reference to the original language text (step S19). Thus, the translator creates a revised translation (improved translation) at the natural language level and finalizes it as an acceptable translation (step S20). Translator terminal 30 transmits the revised translation to server 20 (step S21).

In server 20, natural language pattern learning mechanism 25 performs pattern learning (recognition) with respect to each piece of syntax based on the improved translation to generate natural language patterns (step S22). The generated patterns are added to translation dictionary mechanism 22 (step S23).

The new natural language patterns remain in translation dictionary mechanism 22 in server 20. Consequently, when a subsequent accesses server 20 and has an original language text translated, he/she is more likely to obtain a translation at the natural language level.

All of the above steps are carried out by a program except for the operation performed by a human (e.g., revision of the translation by the translator at step S19).

The translator selects a translation to revise based on the statistics. The selection can be made by the automatic translation server 20.

This is because the fields of the translators are registered in server 20. In addition, thresholds of access frequency and automatic translation grade can be preset for each translator. For example, five times is set as the threshold of access frequency and, on a scale of one to three, “third grade” is set as the threshold grade. An initial translation to be revised is selected using the thresholds based on the translation access statistics recorded by mechanism 24. That is, when the access frequency count and/or automatic translation grade for an initial translation reach the thresholds, the initial translation can be sent. to a translator registered as a specialist together with such information as the positional information of the original text.

In addition, a server can be used as a relational database for storing the initial translation in relation to the original language text. Also, a hyperlink to the original language text can be embedded in the initial translation.

The preferred functioning of the present invention has been described using specific terms. However, such a description is for illustrative purposes only, and it is to be understood that changes and variations can be made without departing from the spirit or the scope of the present invention. For example, the present invention can be applied to an automatic speech (sound-based) translation device as a variation on the above.

Additionally, although Japanese-English translation has been used as an example, the present invention can be applied to the translation of English into Japanese and between other languages.

As set forth hereinabove, in accordance with the present invention, original language text information obtained through a communications network (Internet, etc.) is automatically translated by a device. The translated information is revised to produce a natural translation, which is reflected in the device's database.

Preferably, after the device has automatically translated the original language text, a user gives a grade to the translation. Then, a low-grade translation is revised by a professional translator who is a specialist in the field of the original information. Then, the revision is reflected in the translation device. Accordingly, at the time of the next automatic translation in the same field, a translation at the natural language level is more likely provided.

Moreover, expert and technical knowledge can be reflected in automatic translation device via a network. Therefore, the quality of translation by the device can be raised more easily as compared with conventional techniques for improving the ability of an automatic translation device.

While the preferred functioning of the invention has been described, it is not to be restricted by the embodiment. It is to be limited to such functioning. Those skilled in the art of modifying such functioning can do so, provided they do not depart from the scope and spirit of the following claims.

What is claimed is:

1. An automatic language translation system, wherein original language text information obtained through a communication network is automatically translated by an automatic language translation device, and the translation which has been revised by a translator is reflected in the device for future use.

2. The automatic language translation system claimed in claim 1, wherein the translator is an expert in the field of the original language text information.

3. An automatic language translation system, comprising:
an original language text information sending server for sending original language text information selected by a user via a communication network;
an original language text automatic translating means for automatically translating the original language text information sent from the original language text information sending server into a language specified by the user;
at least one user terminal for instructing the original language text automatic translating means to translate the original language text information into the specified language;
at least one expert terminal used by an expert translator for revising the translation of the original language text information automatically translated at the instruction from the user terminal; and
a communication network for interconnecting the original language text information sending server, the original language text automatic translating means, the user terminal, and the expert terminal; wherein:
the translation automatically translated by the original language text automatic translating means is revised by the expert translator, and the revised translation is reflected in the original language text automatic translating means.

4. The automatic language translation system claimed in claim 3, wherein the user gives a grade to the translation automatically translated by the original language text automatic translating means, and the translation is revised by the expert translator when the grade is low.

5. The automatic language translation system claimed in claim 3, wherein:
the original language text automatic translating means is capable of translating a plurality of languages; and
when there are a plurality of the user terminals, the expert translator revises the translations in descending order of accesses to the original language texts each corresponding to the respective translations made by the user terminals.

6. The automatic language translation system claimed in claim 3, wherein:
the original language text automatic translating means is capable of translating a plurality of languages;
when there are a plurality of the user terminals, respective users give grades to the translations automatically translated by the original language text automatic translating means; and
the expert translator revises the translations which were given low grades by the users in descending order of accesses to the original language texts each corresponding to the respective translations made by the user terminals.

7. The automatic language translation system claimed in claim 3, wherein:
the original language text automatic translating means is capable of translating a plurality of languages;
when there are a plurality of the user terminals, respective users give grades to the translations automatically translated by the original language text automatic translating means;
the grades of the respective translations given by the users are registered in the original language text automatic translating means; and
the expert translator revises the translations which were given low grades in ascending order of the grades.

8. An automatic language translation server, which automatically translates original language text information obtained through a communication network into a language specified by a user, and reflects the translation which has been revised by a translator in future translations.

9. The automatic language translation server claimed in claim 8, which has the translator who is an expert in the field of the original language text information revise the translation.

10. The automatic language translation server claimed in claim 8, wherein the user gives a grade to the translation made by automatic translation, and the translation is revised by the translator when the grade is low.

11. The automatic language translation server claimed in claim 8, which has the translator who is an expert in the field of the original language text information revise the translation, wherein:
the user gives a grade to the translation made by automatic translation, and the translation is revised by the expert translator when the grade is low.

12. The automatic language translation server claimed in claim 8, which has the translator revise the translation made by automatic translation when there are many requests for the translation of the corresponding original language text information from users.

13. The automatic language translation server claimed in claim 8, which has the translator who is an expert in the field of the original language text information revise the translation when there are many requests for the translation of the corresponding original language text information from users.

14. An automatic language translation method, comprising the steps of:
obtaining original language text information selected by a user;
automatically translating the original language text information into a language specified by the user;
having a translator revise the translation made by automatic translation; and
reflecting the revision of the translation made by the translator in future translations.

15. The automatic language translation method claimed in claim 14, wherein the translator is an expert in the field of the original language text information.

16. The automatic language translation method claimed in claim 14, further comprising the steps of:
having the user give a grade to the translation made by automatic translation; and
having the translator revise the translation when the grade is low.

17. The automatic language translation method claimed in claim 14, wherein the translator is an expert in the field of the original language text information, further comprising the steps of:
having the user give a grade to the translation made by automatic translation; and
having the expert translator revise the translation when the grade is low.

18. The automatic language translation method claimed in claim 14, wherein the translator is an expert in the field of the original language text information, further comprising the step of:
having the expert translator revise the translation in descending order of requests for the translation of the corresponding original language text information from users.

19. The automatic language translation method claimed in claim 14, further comprising the steps of:
having respective users give grades to translations made by automatic translation; and
having the translator revise translations which were given low grades by the users in descending order of requests for the translation of the corresponding original language text information from the users.

20. The automatic language translation method claimed in claim 14, wherein the translator is an expert in the field of the original language text information, further comprising the steps of:
having respective users give grades to translations made by automatic translation; and
having the expert translator revise translations which were given low grades by the users in descending order of requests for the translation of the corresponding original language text information from the users.

21. A program for executing the process of:
obtaining original language text information selected by a user;
automatically translating the original language text information into a language specified by the user;
having a translator revise the translation made by automatic translation; and
reflecting the revision of the translation made by the translator in future translations.

22. The program claimed in claim 21, wherein the translator is an expert in the field of the original language text information.

23. The program claimed in claim 21, for further executing the process of:
having the user give a grade to the translation made by automatic translation; and
having the translator revise the translation when the grade is low.

24. The program claimed in claim 21, wherein the translator is an expert in the field of the original language text information, for further executing the process of:
having the user give a grade to the translation made by automatic translation; and
having the expert translator revise the translation when the grade is low.

25. The program claimed in claim 21, wherein the translator is an expert in the field of the original language text information, for further executing the process of:
having the expert translator revise the translation in descending order of requests for the translation of the corresponding original language text information from users.

26. The program claimed in claim 21, for further executing the process of:
having respective users give grades to translations made by automatic translation; and
having the translator revise translations which were given low grades by the users in descending order of requests for the translation of the corresponding original language text information from the users.

27. The program claimed in claim 21, wherein the translator is an expert in the field of the original language text information, for further executing the process of:
having respective users give grades to translations made by automatic translation; and
having the expert translator revise translations which were given low grades by the users in descending order of requests for the translation of the corresponding original language text information from the users.
